(19) United States
(12) Patent Application Publication
(10) Pub. No.: US 2011/0192202 A1
(43) Pub. Date: Aug. 11, 2011

(54) TUBULAR LOCK SAFETY STRUCTURE

(76) Inventors: LI-JEN CHANG, NEW TAIPEI CITY (TW); LI-SHIH LIAO, TAOYUAN COUNTY (TW)

(21) Appl. No.: 13/014,839

(22) Filed: Jan. 27, 2011

(30) Foreign Application Priority Data
Feb. 9, 2010 (CN) 201010301405.0
Sep. 3, 2010 (TW) 099129803

(51) Int. Cl. E05B 9/04

(52) U.S. Cl. 70/449

(57) ABSTRACT

A tubular lock safety structure comprises a lock cylinder assembly and a lock core assembly having a lock core body, at least one set of flat key wafer and an equal number of elastic elements. The blocking ring of the lock cylinder assembly is sheathed on the lock core body, and a plurality of transverse guide slots is formed on an external wall of the lock core body for accommodating the flat key wafers and the elastic elements, and the flat key wafer can be fixed and reset in the guide slot by the elastic element, and each flat key wafer has at least one combination notch. If a key is inserted into the lock core to push the flat key wafer, each combination notch will be aligned with the lock block and set to a free state for unlocking.

### BACKGROUND OF THE INVENTION

(a) Field of the Invention

The present invention relates to a tubular lock safety structure, and more particularly to a lock core structure composed of a blocking ring and a plurality of flat key wafers with different combination notches.

(b) Description of the Related Art

Among various different types of locks, a tubular lock is applicable for a master key system and thus it is used extensively in many areas including lockers, cabins, file cabinets and drawers. With reference to FIGS. 1, 2A and 2B for an exploded view and cross-sectional views of a conventional tubular lock 50 respectively, the tubular lock 50 comprises a lock cylinder 51, a lock core 52, a positioning body 53, a slave pin 54, a master pin 55 and a spring 56. After the lock core 52 is combined with the positioning body 53, the lock core 52 is fixed into the lock cylinder 51, and a copper pin 58 is passed through the lock cylinder 51 and the positioning body 53. The lock core 52 and the positioning body 53 have a plurality of corresponding axial holes 521, 531 formed thereon, and each hole is aligned and installed sequentially with the spring 56, the master pin 55 and the slave pin 54. Normally, the slave pin 54 falls into the hole 521 of the lock core 52 completely, and the master pin 55 is set across the positioning body 53 and the lock core 52 by the pushing force of the spring 56, such that the lock core 52 cannot be turned in the lock cylinder 51. When the lock is unlocked, a key 57 with tooth grooves 571 of different depths is used to push the slave pin 54 inward, and the front end of the master pin 55 is situated precisely at the position X-X of a gap between the positioning body 53 and the lock core 52. Now, the lock core 52 can be turned in the lock cylinder 51 to achieve the locking and unlocking effects. However, such tubular lock 50 has the following two major drawbacks:

1. The master pin 55 is situated transversally across the positioning body 53 and the lock core 52 by the pushing force of the spring 56 as shown in FIG. 2B. As a result, if the slave pins 54 are tapped with an appropriate force, the master pins 55 will be retracted into the axial holes 531 of the positioning body 53 to unlock the lock without using a key.

2. The master pin 55 and the spring 56 of a same lock core 52 are of the same size, and the position of each master pin 55 varies with the length of each slave pin 54. In this way, the same pressure can be applied at the slave pins 54 to return the master pins 55 to the same position to unlock the lock without using a key. Therefore, the structure of the aforementioned tubular lock 50 is lack of safety and security.

With reference to FIGS. 3, 4A and 4 B for an improved tubular lock as disclosed in Taiwan Pat. No. 363652, the tubular lock 60 comprises a lock body 61, a main control lock shaft 62, a sleeve 63, a plurality of compression springs 64 and a cylindrical body 65. The lock body 61 includes an external decorative plate 611, a penetrating hole 612 and a bolt pin 613. The lock body 61 is provided for containing the main control lock shaft 62. The main control lock shaft 62 includes a main body 621 and a lock core 622. The lock core 622 is fixed into the main body 621, and a plurality of C-shaped slots 623 is concavely formed at the external edge of the main body 621 of the main control lock shaft 62, and each C-shaped slot 623 is provided for accommodating the compression spring 64 and the cylindrical body 65, and each cylindrical body 65 has a prop lump 651. In this way, when the cylindrical body 65 is accommodated in the C-shaped slot 623, the external periphery of the cylindrical body 65 provides a space for moving the prop lump 651 of the cylindrical body 65. A key 66 comes with a predetermined depth that is matched with the prop lump 651 of the cylindrical body 65, such that when the key 66 is inserted into the main control lock shaft 62, the cylindrical body 65 presses the compression spring 64 to produce a different pressing force according to the distance of the prop lump 651 of the cylindrical body 65 and each prop lump 651 can be locked or released with respect to a reference line, and the main control lock shaft 62 can turn the lock to achieve the locking and unlocking effects.

However, in the tubular lock 60 of this type, the prop lump 651 of each cylindrical body 65 is moved within the radial circular groove d formed between the axial groove 614 in the lock body 61 and the corresponding axial groove 632 in the sleeve 63 and situated on the reference line, such that the lock can be unlocked. In other words, each cylindrical body 65 can have one prop lump 651 only and cannot have two or more prop lumps 651. Such limitation does not allow the development of a combination lock, since this type of tubular lock 60 can be cracked easily and it is lack of safety and security.

### SUMMARY OF THE INVENTION

Therefore, it is an object of the present invention to provide a tubular lock safety structure featuring a simple assembly and a convenient manufacture and providing a design of controlling the predetermined combination notches of the flat key wafer together with a blocking ring to achieve the effect of enhancing the security of the lock.

Another object of the present invention is to add at least one combination notch on the assembled flat key wafer, so as to achieve the effect of increasing the lock combination numbers.

The other object of the present invention is to add security measures including a number cracking-proof groove and a probe-proof step to the assembled flat key wafer, so as to achieve the effect of preventing unauthorized unlocking.

In order to achieve the above-mentioned object, the invention includes:

a) a lock cylinder assembly, having a lock cylinder body, a blocking ring, and a positioning sleeve, a keyhole formed at a front end of the lock cylinder body, a first accommodating groove and a second accommodating groove formed in the lock cylinder body, and a stair-shaped circular flat bottom formed between the first accommodating groove and the second accommodating groove, and the blocking ring being positioned in the second accommodating groove by the positioning sleeve and attached onto the circular flat bottom, and a plurality of lock blocks being radially arranged on an internal wall of the blocking ring, and a passage being formed between two adjacent lock blocks; and

b) a lock core assembly, installed in the lock cylinder assembly, and having a lock core body, a plurality of flat key wafers and an equal number of elastic elements, and the lock core body having an internal shaft, a front flange portion extended from the exterior of the internal shaft and disposed in the first accommodating groove of the lock cylinder assembly, and a rear flange portion, and a plurality of axial guide slots being formed on external walls of the front and rear flange portions for accommodating the flat key wafers and the elastic elements, and each flat key wafers having at least one combination notch formed at a position corresponding to a bitting of a key;

whereby, when the tubular lock is situated at a lock position, each flat key wafer is acted by the elastic element to attach onto an internal wall of a keyhole of the lock cylinder body, and the flat key wafer is limited by the lock block to prevent a circular motion to assure that the lock core assembly remains at a lock state during an unauthorized unlocking, and the flat key wafer requires a key with a pre-made bitting to push each flat key wafer, such that each combination notch is aligned with the lock block and set to a free state, and the key can be turned to drive the lock core assembly to perform the circular motion in order to set the tubular lock to an unlock state.

According to the invention, the flat key wafer has more than one number cracking-proof grooves formed in a direction parallel to the combination notch, and the number cracking-proof grooves are formed on recessed surfaces on both sides of the flat key wafer respectively.

According to the invention, the flat key wafer has a probe-proof step formed at a direction perpendicular to the combination notch, and the probe-proof step is formed on a surface with a sectional difference on both sides of a lower section of the flat key wafer.

In addition, the tubular lock in accordance with the invention may work with all kinds of latching elements.

### BRIEF DESCRIPTION OF THE FIGURES

FIG. 1 is an exploded perspective view of a conventional tubular lock;

FIGS. 2A and 2B are cross-sectional views of the conventional tubular lock in FIG. 1;

FIG. 3 is an exploded perspective view of another conventional tubular lock;

FIGS. 4A and 4B are cross-sectional views of the conventional tubular lock in FIG. 3;

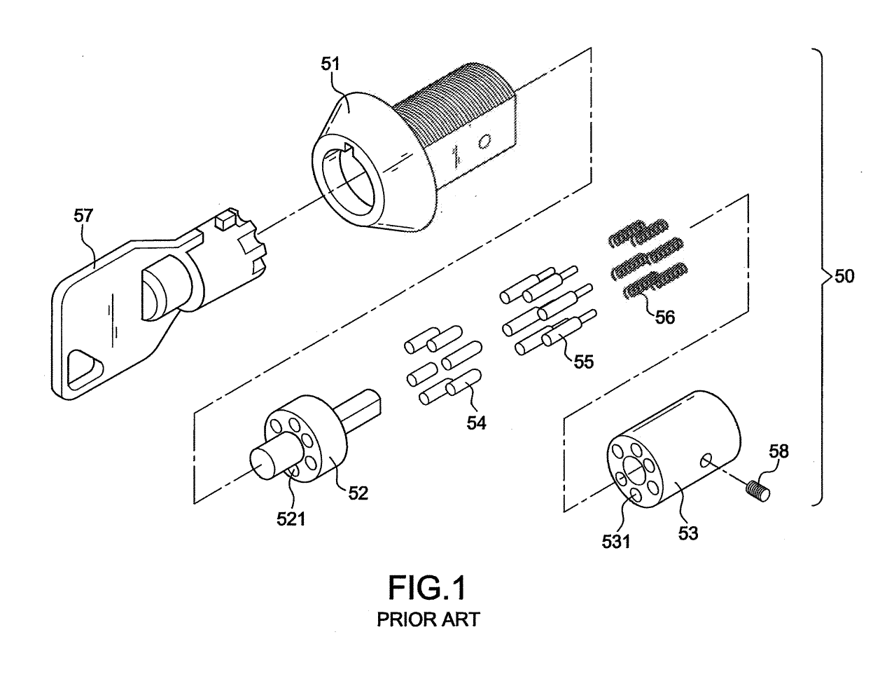

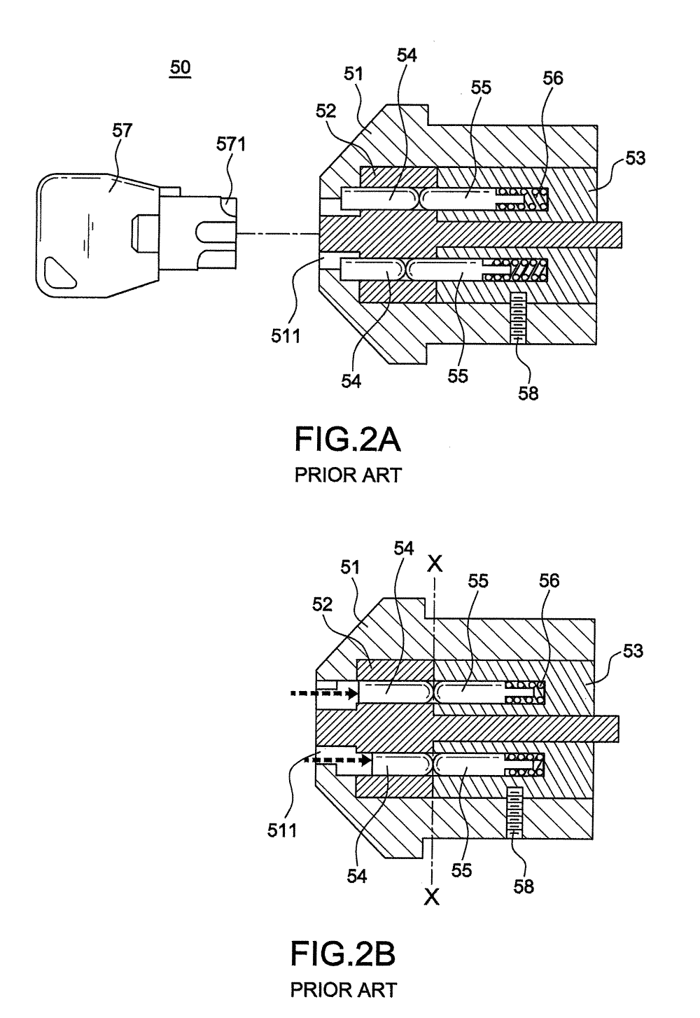

FIGS. 1 to 4 are schematic views of a conventional tubular lock;

FIG. 5 is an exploded perspective view of a preferred embodiment of the present invention;

FIG. 6 is a perspective view of a preferred embodiment of the present invention;

FIG. 7 is a partial cutaway view I of FIG. 6;

FIG. 8 is a partial cutaway view II of FIG. 6;

FIG. 9 is a cross-sectional view taken along the line 9-9 of FIG. 6;

FIG. 10 is a schematic view I of unlocking a tubular lock by a key in accordance with the present invention;

FIG. 11 is a schematic view II of unlocking a tubular lock by a key in accordance with the present invention;

FIG. 12A is a perspective view of a flat key wafer in accordance with the present invention;

FIG. 12B is a perspective view of another flat key wafer in accordance with the present invention;

FIG. 13 is a schematic view showing the relation between a flat key wafer and a blocking ring in accordance with the present invention;

FIG. 14 is an exploded perspective view of another preferred embodiment of the present invention;

FIG. 15 is an exploded perspective view of an application of the present invention; and

FIG. 16 is a perspective view of an application of the present invention.

### DETAILED DESCRIPTION OF THE PREFERRED EMBODIMENT

With reference to FIGS. 5 to 13 for a tubular lock safety structure in accordance with a preferred embodiment of the present invention, the tubular lock safety structure comprises a lock cylinder assembly 20 and a lock core assembly 11.

The lock cylinder assembly 20 includes a lock cylinder body 21, a blocking ring 22 and a positioning sleeve 23. A keyhole 214 is formed at a front end of the lock cylinder body 21 for inserting a key 30 as shown in FIG. 10, and a first accommodating groove 211 is defined in the lock cylinder body for accommodating the lock core assembly 11, and a second accommodating groove 212 with a diameter and dimensions capable of accommodating the blocking ring 22 and the positioning sleeve 23, and the positioning sleeve 23 is coupled and secured with the lock cylinder body 21. A stair-shaped circular flat bottom 213 is formed between the first accommodating groove 211 and the second accommodating groove 212. The blocking ring 22 is sheathed on the external periphery of the rear flange portion 123 of the lock core body 12, disposed in the second accommodating groove 212 of the lock cylinder body 21, and aligned evenly with the circular flat bottom 213. The blocking ring 22 includes a plurality of lock blocks 221 arranged radially on an internal wall of the blocking ring 22 and a passage 222 formed between two adjacent lock blocks 221.

The lock core assembly 11 includes a lock core body 12, at least one set of flat key wafer 13 and a plurality of elastic elements 14 such as springs, and the number of elastic elements 14 is equal to the number of flat key wafers 13. The lock core body 12 includes an internal shaft 121, a front flange portion 122 extended from the exterior of the internal shaft 121 and disposed in the first accommodating groove 211 of the lock cylinder body 21, and a rear flange portion 123. A plurality of axial guide slots 124 is formed on external walls of the front flange portion 122 and the rear flange portion 123 for accommodating the flat key wafer 13 and the elastic element 14, and the flat key wafer 13 is fixed and reset in the axial guide slots 124 by the elastic element 14. Each flat key wafer 13 has at least one combination notch 131 that can be applied to the master key system, and each combination notch 131 is formed at a position corresponding to a bitting 31 of the key 30, so that each combination notch 131 is formed with a different depth and at a different position.

If the tubular lock 10 is situated at a lock state, the flat key wafer 13 is acted by the elastic element 14 and attached onto the internal wall of a keyhole 214 of the lock cylinder body 21, and the flat key wafer 13 is acted by a pushing force to move axially along the guide slot 124 in the passage 222 of the blocking ring 22. After the pushing force is released, the flat key wafer 13 is acted by the elastic element 14 and reset to the original starting position on the internal wall of the keyhole 214 of the lock cylinder body 21. In an unauthorized unlocking, the flat key wafer 13 is limited by the lock block 221 and cannot perform a circular motion, so that the lock core assembly 11 can not be turned, and it is situated at the lock state.

With reference to FIGS. 10 and 11 for an operation method of unlocking the tubular lock 10 of the present invention by using a special key. Firstly, the special key 30 is inserted into the keyhole 214, and the pre-made bitting 31 of the key 30 can push the flat key wafer 13 to move the combination notch 131 of each flat key wafer 13 inward and to be aligned with the lock block 221 to define a free state as shown in FIG. 10. And then, the key 30 is turned to drive the lock core assembly 11 to perform a circular motion, and the tubular lock 10 can be set to an unlock state as shown in FIG. 11.

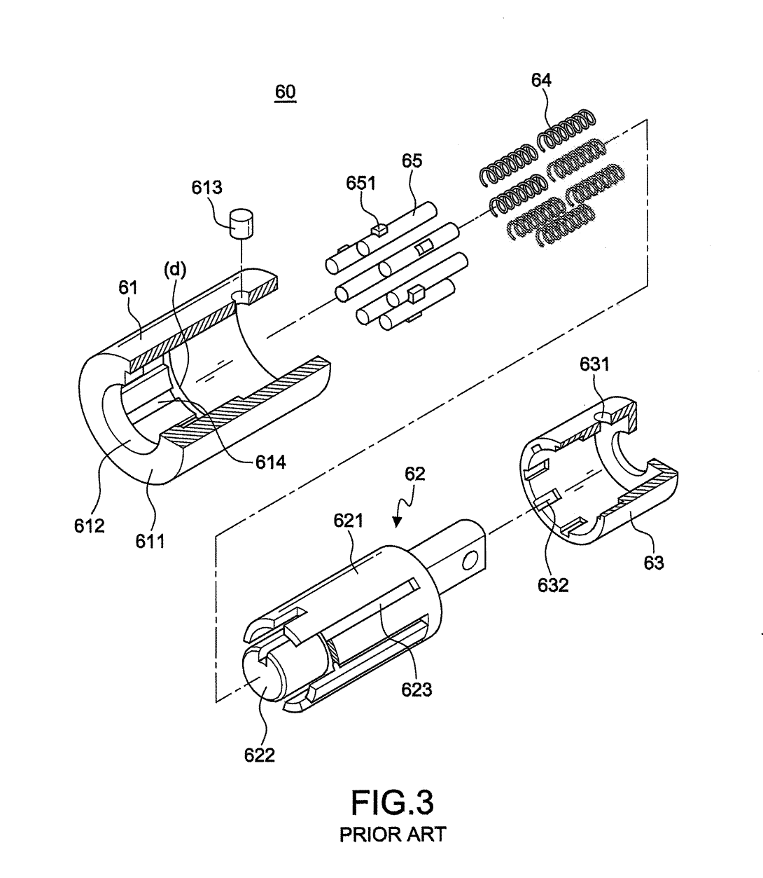

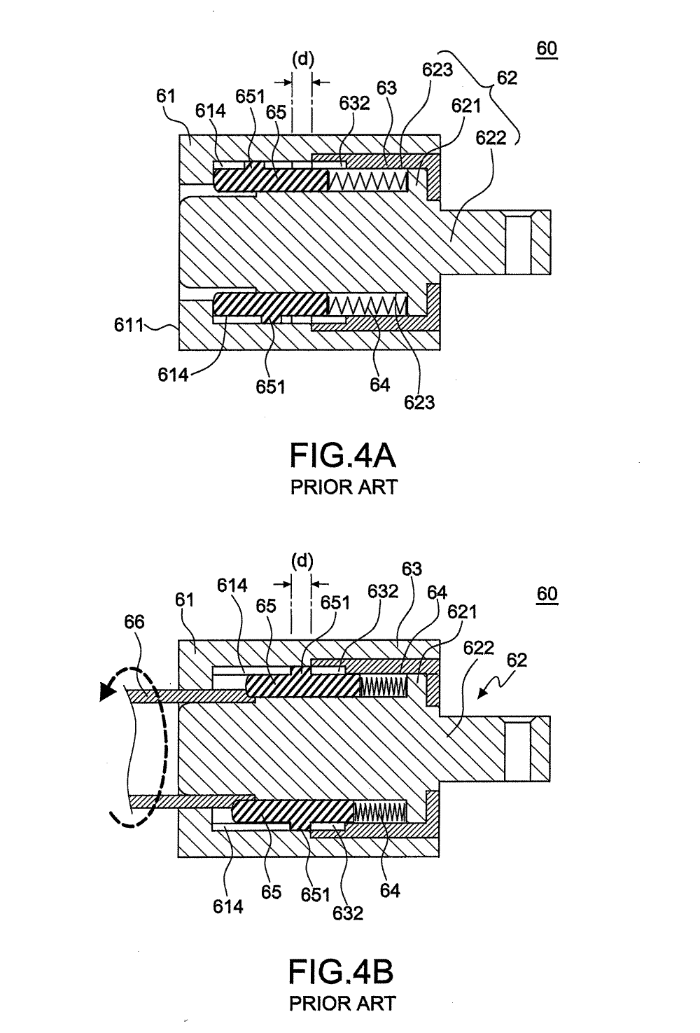

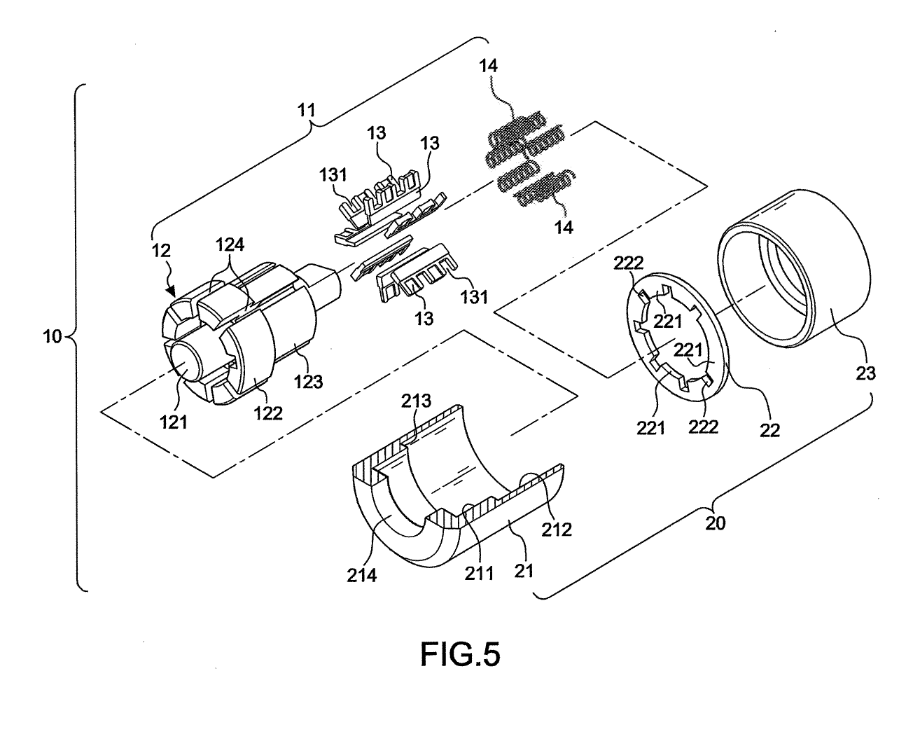

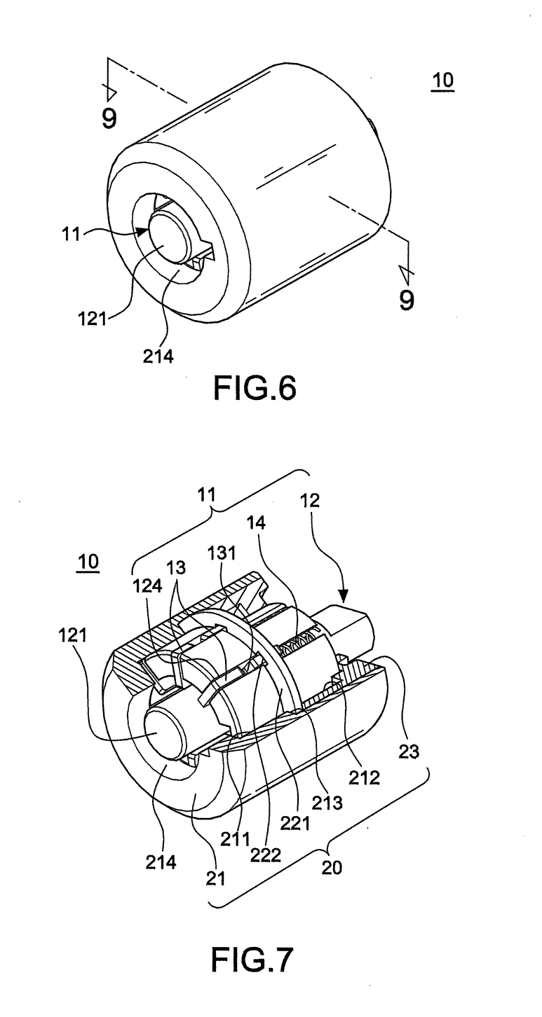

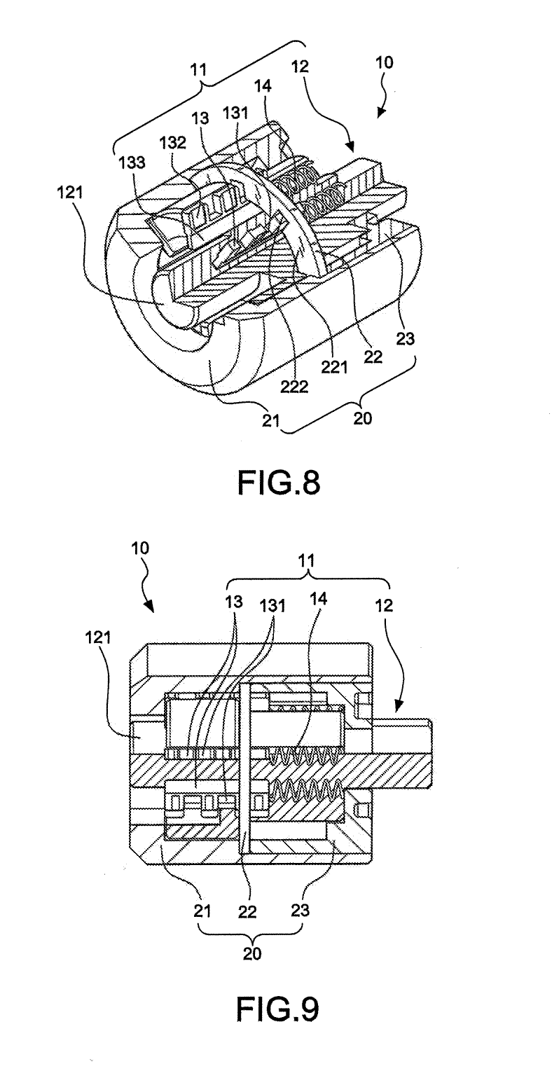

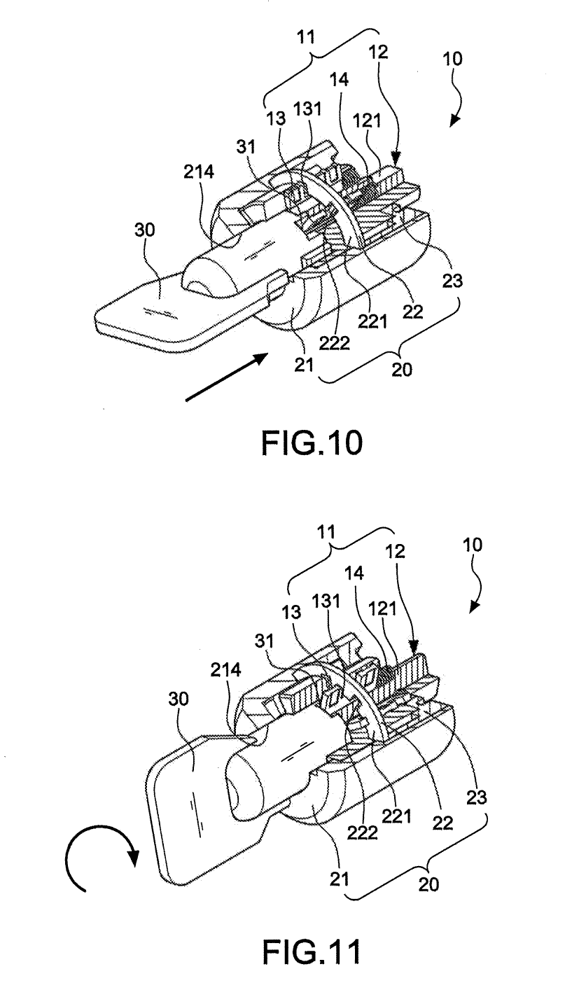

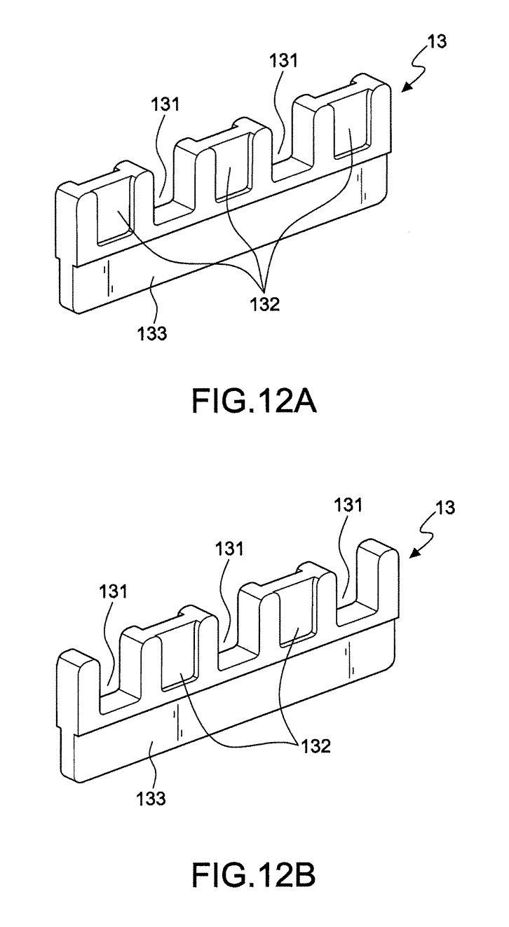

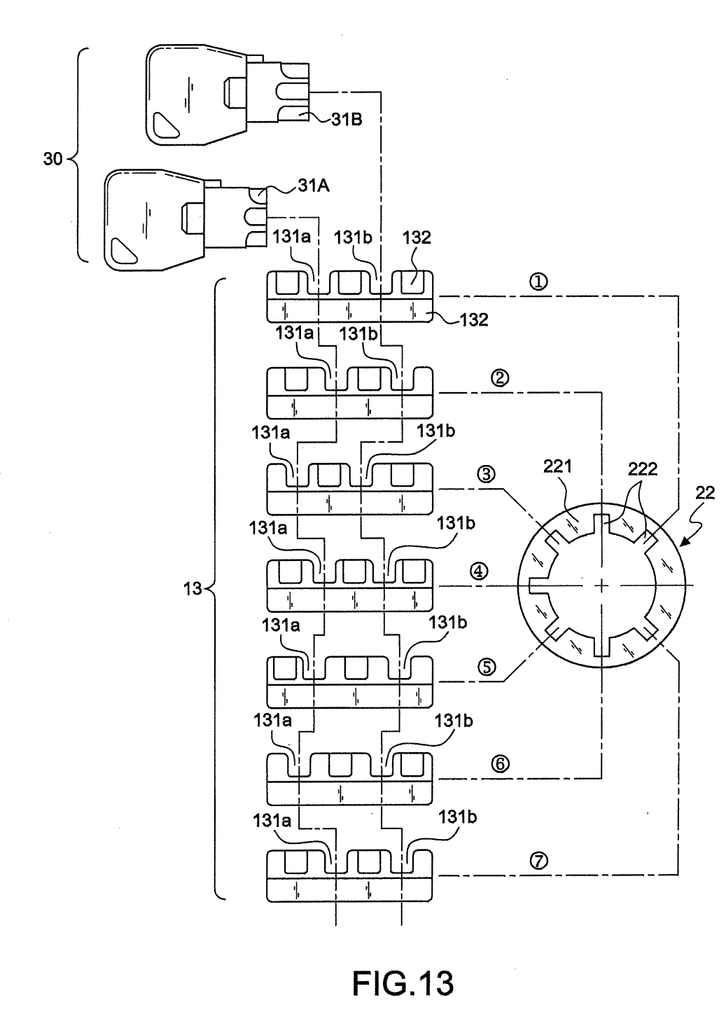

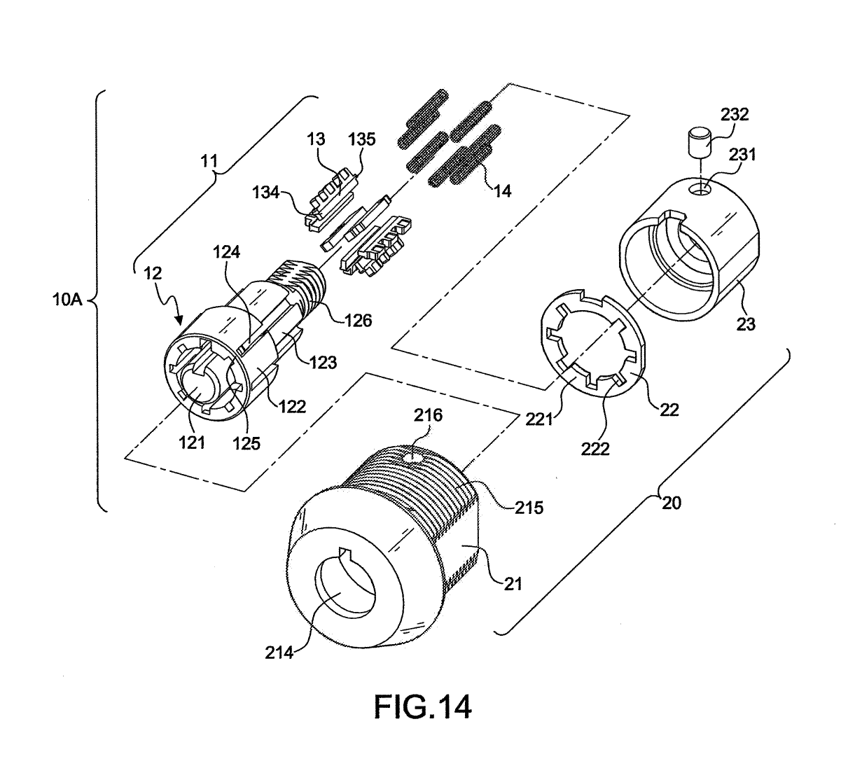

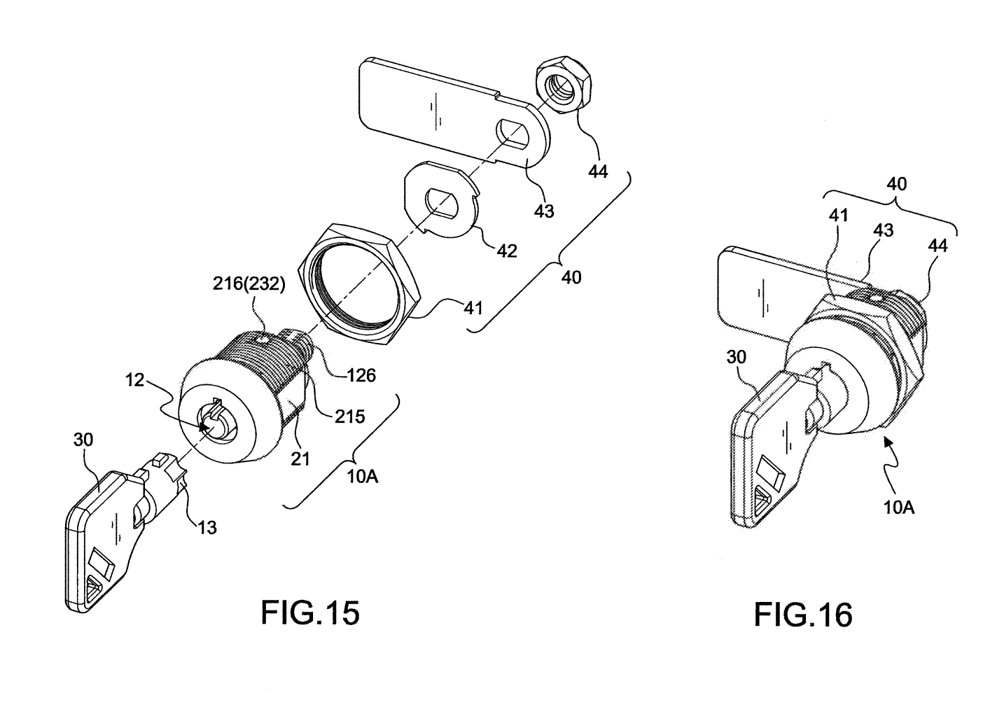

The present invention is also characterized in that the flat key wafer 13 comprises at least a combination notch 131. It can be with two combination notches 131 as shown in FIG. 12A, or three combination notches 131 as shown in FIG. 12B, such that the tubular lock assembly can be applied to a master key system, and the number of combinations can be increased, and the position of each combination notch 131a, 131b is matched with the pre-made bitting 31A, 31B of the key 30 as shown in FIG. 13. The flat key wafer 13 of the present invention can come with two or three combination notches 131 to fit the design of the blocking ring 22, such that when each combination notch 131 reaches the passage 222 of the blocking ring 22, it will not be limited by the lock block 222 and will have a circular motion for the unlocking. On the other hand, there is only one prop lump 651 for each cylindrical body 65 of the conventional tubular lock 60 as shown in FIG. 3 and FIG. 4. If there are two or more prop lumps 651 and one of the prop lumps 651 is disposed on a reference line of the radial circular groove d, then the other prop lump 651 has no corresponding radial circular groove and cannot be turned. Therefore, the present invention can use the design of the combination notch 131 corresponding to the blocking ring 22 to overcome the aforementioned problem and achieve the effect of increasing the lock combination numbers. For example, there are seven passages 222 of the blocking ring 22 as shown in FIG. 13 to work with the first \textcircled{1} to seventh \textcircled{7} flat key wafers 13. If the first bitting 31A of the key 30 pushes the combination notch 131a of each flat key wafer 13 to the passage 222 of the blocking ring 22, then the lock can be turned to an unlock state, or if the second bitting 31B pushes the combination notch 131b of each flat key wafer 13 to the passage 222 of the blocking ring 22, the lock can be turned to an unlock state as well.

In FIGS. 12A and 12B, the flat key wafer 13 of the present invention includes more than one number cracking-proof groove 132 formed in a direction parallel to the combination notch 131, and the number cracking-proof groove 132 is formed on a recessed surface on both sides of the flat key wafer 13, and a probe-proof step 133 is formed in a direction perpendicular to the combination notch 131 on a surface with a sectional difference on both sides of a lower section of the flat key wafer 13.

If the tubular lock 10 is situated at a lock state, the flat key wafer 13 is acted by the elastic element 14 to attach onto the internal wall of the keyhole 214 of the lock cylinder body 21, and the flat key wafer 13 is pushed by a pushing force to axially move along the guide slot 124 in the passage 222 of the blocking ring 22. After the pushing force is released, the flat key wafer 13 is acted by the elastic element 14 to reset to its original starting position on the internal wall of the keyhole 214 of the lock cylinder body 21. In an unauthorized unlocking, the flat key wafer 13 is limited by the lock block 221 and cannot perform a circular motion, so that the lock core assembly 11 cannot be turned and it is situated at the lock state.

In an unauthorized unlocking of the tubular lock 10, the flat key wafer 13 is pushed to drive the combination notch 131 to produce an interference with the lock block 221 and the number cracking-proof groove 132 to produce an interference with the lock block 221, so as to confuse the unauthorized person about the correct position of the combination notch 131 and prevent the combination notch 131 from producing interferences to the lock block 221 by pushing the flat key wafer 13 for the purpose of locating the position of the combination notch 131. In addition, the probe-proof step 133 can prevent the unauthorized person from inserting a probe into the gap between the flat key wafer 13 and the guide slot 124 for the purpose of locating the position of the combination notch 131. Practically, the guide slot 124 of the lock core body 12 can be formed on a surface with a cross-sectional difference and in a stair shape to prevent the insertion of the probe, so as to enhance the safety and security of the tubular lock 10.

With reference to FIGS. 14 to 16 for another preferred embodiment of the present invention, same components of the foregoing preferred embodiment are represented by the same respective numerals in this preferred embodiment, and the difference of this preferred embodiment from the foregoing preferred embodiment resides on that the lock core body 12 has a sealed positioning surface 125 disposed at the front end of the guide slot 124. A front protruding lump 134 is disposed at the bottom of the front end of the flat key wafer 13, and a rear protruding lump 135 is disposed at a back end of the flat key wafer 13 corresponding to the elastic element 14 for facilitating the positioning and assembling of the components.

In addition, the lock cylinder body 21 has a first screw tooth 215 formed at the external periphery of the lock cylinder body 21 and a first positioning hole 216 formed axially, and the positioning sleeve 23 has a second positioning hole 231 disposed opposite to the first positioning hole 216, and the first and second positioning holes 216, 231 are fixed by a radial pillar 232 or a screw to assemble the tubular lock 10A as shown in FIGS. 15 and 16 such that the tubular lock 10 can be combined with a lock latch 40 in a convenient way. In other words, the lock cylinder body 21 is connected with a first nut 41 at the first screw tooth 215, and the back end 126 of the lock core body 12 is fixed and coupled to a blocking plate 42 and a tongue 43 by a second nut 44 to link with the lock core body 12. However, this embodiment is used for illustrating the present invention but not for limiting the scope of the present invention.

Compared with the prior arts, the technical measures taken by the present invention have the following advantages and effects:

1. A conventional tubular lock makes use of controlling the position of the gap between the master pin and the slave pin to achieve the unlocking effect. Since the gap is not constant, but it is controlled by the elastic element, an appropriate tap may offset the force of the elastic element, and the gap will be increased instantly to allow unauthorized unlocking. On the other hand, the present invention makes use of controlling the position of the combination notches of the flat key wafers to achieve the unlocking effect. Since the size of the combination notch of the flat key wafer is constant, the invention can prevent the tubular lock from being unlocked without authorization.

2. The key point of unlocking the tubular lock of the present invention resides on that the combination notch of each flat key wafer must be aligned precisely with the lock block. Because of the different position of each combination notch, even if the same pressure is applied to press each flat key wafer, each combination notch can be moved synchronously only, and no passage can be formed for the unlocking. Therefore, the present invention can enhance the safety and security of the tubular lock.

3. The present invention can add prevention measures such as the number cracking-proof groove and the probe-proof step on the flat key wafer of the lock core assembly to prevent unauthorized unlocking, so as to further enhance the safety and security of the tubular lock.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A tubular lock safety structure, comprising:
a) a lock cylinder assembly, having a lock cylinder body, a blocking ring, and a positioning sleeve, a keyhole formed at a front end of the lock cylinder body, a first accommodating groove and a second accommodating groove formed in the lock cylinder body, and a stair-shaped circular flat bottom formed between the first accommodating groove and the second accommodating groove, and the blocking ring being positioned in the second accommodating groove by the positioning sleeve and attached onto the circular flat bottom, and a plurality of lock blocks being radially arranged on an internal wall of the blocking ring, and a passage being formed between two adjacent lock blocks; and
b) a lock core assembly, installed in the lock cylinder assembly, and having a lock core body, a plurality of flat key wafers and an equal number of elastic elements, and the lock core body having an internal shaft, a front flange portion extended from the exterior of the internal shaft and disposed in the first accommodating groove of the lock cylinder assembly, and a rear flange portion, and a plurality of axial guide slots being formed on external walls of the front and rear flange portions for accommodating the flat key wafers and the elastic elements, and each flat key wafers having at least one combination notch formed at a position corresponding to a bitting of a key;
whereby, when the tubular lock is situated at a lock position, each flat key wafer is acted by the elastic element to attach onto an internal wall of a keyhole of the lock cylinder body, and the flat key wafer is limited by the lock block to prevent a circular motion to assure that the lock core assembly remains at a lock state during an unauthorized unlocking, and the flat key wafer requires a key with a pre-made bitting to push each flat key wafer, such that each combination notch is aligned with the lock block and set to a free state, and the key can be turned to drive the lock core assembly to perform the circular motion in order to set the tubular lock to an unlock state.

2. The tubular lock safety structure as recited in claim 1, wherein the blocking ring of the lock cylinder assembly is sheathed on the external periphery of the rear flange portion of the lock core body, disposed in the second accommodating groove of the lock cylinder body, and aligned evenly with the circular flat bottom.

3. The tubular lock safety structure as recited in claim 1, wherein the flat key wafer has more than one number cracking-proof grooves formed in a direction parallel to the combination notch, and the number cracking-proof grooves are formed on recessed surfaces on both sides of the flat key wafer respectively.

4. The tubular lock safety structure as recited in claim 1, wherein the flat key wafer has a probe-proof step formed at a direction perpendicular to the combination notch, and the probe-proof step is formed on a surface with a sectional difference on both sides of a lower section of the flat key wafer.

5. The tubular lock safety structure as recited in claim 1, wherein the lock core body has a sealed positioning surface formed at a front end of the axial guide slot of the lock core body, and the flat key wafer has a corresponding front protruding lump formed at the bottom of the front end of the flat key wafer, and a rear protruding lump formed at a back end of the flat key wafer and corresponding to the elastic element.

6. The tubular lock safety structure as recited in claim 1, wherein the lock cylinder body includes a screw tooth disposed at the external periphery of the lock cylinder body, a first positioning hole formed in a radial direction, and a second positioning hole formed at the positioning sleeve and disposed opposite to the first positioning hole, and the first and second positioning holes are fixed by a radial pillar.

7. The tubular lock safety structure as recited in claim 6, wherein the lock cylinder body includes a first nut installed at the external periphery of the lock cylinder body, and the back end of the lock core body is fixed and coupled to a blocking plate and a tongue by a second nut, such that the blocking plate and the tongue are linked with the lock core body.
